(19) United States
(12) Patent Application Publication
(10) Pub. No.: US 2025/0010261 A1
(43) Pub. Date: Jan. 9, 2025

(54) DEVICE AND METHOD FOR GAS CONVERSION

(71) Applicant: UNIVERSITEIT ANTWERPEN, Antwerpen (BE)

(72) Inventors: Annemie BOGAERTS, Wommelgem (BE); Fanny GIRARD-SAHUN, Wilrijk (BE); Georgi TRENCHEV, Antwerpen (BE)

(21) Appl. No.: 18/705,237

(22) PCT Filed: Oct. 25, 2022
(86) PCT No.: PCT/EP2022/079789

§ 371 Date: Apr. 26, 2024

(30) Foreign Application Priority Data
Nov. 2, 2021 (EP) 21206103.0

(51) Int. Cl. B01J 8/08; B01J 8/00; B01J 8/10; B01J 8/12; C01B 32/40

(52) U.S. Cl. CPC B01J 8/085; B01J 8/003; B01J 8/0035; B01J 8/10; B01J 8/12; C01B 32/40; B01J 2208/00752; B01J 2208/00867

(57) ABSTRACT

The present disclosure relates to a device for gas conversion comprising a plasma reactor and a chamber configured for receiving a gas flow of converted and unconverted feed gas evacuated from the plasma reactor. The chamber comprises a supply throughput for filling the chamber with solid reactant material so as to form the fixed bed of solid reactant material, and at least one gas exhaust window for extracting a product gas. The device for gas conversion further comprises a silo for storing a stock of the solid reactant material and a connecting tube connecting a bottom opening of the silo with the supply throughput of the chamber. The silo and the connecting tube are configured such that, when the device is in operation and solid reactant material is being depleted in the chamber, a flow of solid reactant material from the silo to the chamber is induced so as to maintain the chamber filled with solid reactant material, and wherein the flow of solid reactant material from the silo to the chamber is induced by a gravitational force or at least partly by a gravitational force. The present disclosure also relates to a method for gas-conversion.

### FIELD OF THE DISCLOSURE

The present disclosure relates to a device for gas conversion comprising a plasma reactor wherein, when in operation, a plasma is formed. The plasma reactor comprises one or more gas inlets configured for introducing a feed gas into the plasma reactor, and a gas outlet for evacuating a gas flow of converted and unconverted feed gas from the plasma reactor.

### BACKGROUND

Plasma reactors for plasma-based gas conversion are gaining an increased interest for a variety of chemical reaction applications.

An example of the potential benefit of using plasma reactors is for the reduction of CO₂ levels in the earth atmosphere, namely by transforming CO₂ into value-added chemicals or renewable fuels. Indeed, with a plasma reactor, CO₂ can be directly split into CO and O₂ and the CO can be used as a chemical feedstock for the production of value-added chemicals or renewable fuels, as discussed for example by Snoeckx and Bogaerts in Chem. Soc. Rev. 2017, 46, 5805.

A conversion for CO₂ of up to 8.6% has been reported with a gliding arc plasma reactor. Although these results of conversion of CO₂ into CO with plasma reactors show to be promising, in order for the plasma reactor technology to become commercially attractive for large scale applications, further improvements are still desirable. What is important is to obtain a higher conversion, ideally 100%, and the energy consumption, also named energy cost, generally expressed in Joules per mol of feed gas, should be as low as possible.

Further, to be directly applicable for industrial applications, ideally O₂ free exhaust gas is needed, i.e. the exhaust gas should only contain pure CO. Indeed, when CO₂ is dissociated, atomic oxygen is produced as well, and it will be responsible of unwanted back reactions, i.e. by recombining with CO into CO₂, lowering the net conversion and energy efficiency. Also, O₂ formed by recombination of two O atoms, can recombine with CO into CO₂. Therefore, both O and O₂ are undesirable species that need to be either physically or chemically quenched to avoid reverse reactions and to reduce separation costs downstream.

Hence there is room for improving devices for gas conversion based on plasma reactors.

### SUMMARY

It is an object of the present disclosure to provide a device for gas conversion wherein oxygen levels in a product gas are reduced when compared to prior art gas conversion devices. More specifically, it is an object to provide a device for converting CO₂ into CO wherein the O₂ exhaust levels are strongly reduced when compared to prior art gas conversion devices. Preferably, O₂ exhaust levels are below 5%, and more preferably below 1%. It is a further objective to provide a device for gas conversion wherein the production yield of the product gas, e.g. CO, is increased and/or energy cost is reduced when compared to prior art plasma reactors for plasma-based gas conversion.

The present invention is defined in the appended independent claims. The dependent claims define advantageous embodiments.

According to a first aspect of the present disclosure, a device for gas conversion is provided comprising a plasma reactor for generating a plasma and a chamber coupled to the plasma reactor.

The plasma reactor comprises one or more gas inlets configured for introducing a feed gas into the plasma reactor and a gas outlet for evacuating a gas flow of converted and unconverted feed gas from the plasma reactor. The chamber is configured for receiving the gas flow of converted and unconverted feed gas evacuated through the gas outlet of the plasma reactor and the chamber is further configured for holding a fixed bed of solid reactant material. The chamber further comprises a supply throughput 28 for filling the chamber with the solid reactant material so as to form the fixed bed of solid reactant material. The chamber comprises at least one gas exhaust window for extracting a product gas from the chamber.

The device for gas conversion according to the present disclosure is characterized in that it comprises a silo for storing a stock of the solid reactant material, and wherein the silo comprises a bottom side having a bottom opening for evacuating solid reactant material from the silo and a connecting tube connecting the bottom opening of the silo with the supply throughput of the chamber. The silo and the connecting tube are configured such that, when the device is in operation and solid reactant material is being depleted in the chamber, a flow of solid reactant material from the silo to the chamber is induced so as to maintain the chamber filled with solid reactant material, and wherein the flow of solid reactant material from the silo to the chamber is induced by a gravitational force or at least partly by a gravitational force.

Advantageously, with the device according to the present disclosure, gas conversion is performed in two stages, during a first conversion stage inside the plasma reactor, the feed gas is decomposed due to an interaction of the feed gas with the plasma, and during a second stage inside the chamber filled with the reactant material, gases exiting the plasma reactor can further interact with the fixed bed of reactant material. In this way, the overall efficiency for gas conversion of for example CO₂ into CO is improved and the oxygen levels of the product gas extracted from the chamber are strongly reduced.

Advantageously, with the device according to the present disclosure, when solid reactant material is depleted, fresh solid reactant material is automatically supplied at a rate corresponding to the depletion rate.

Advantageously, the device for gas conversion according to the present disclosure can operate in a continuous mode without need to stop operations for refilling the plasma chamber with reactant material.

Generally, the plasma reactor comprises a central reactor axis that is passing through at least one gas outlet, and the chamber is elongating along the central reactor axis from a first end to a second end.

In embodiments, a first end of the chamber comprises an axial entrance opening, and wherein the gas outlet of the plasma reactor is facing the axial entrance opening of the chamber such that, when the device is in operation, converted and unconverted feed gas exiting the plasma reactor enter the chamber.

In embodiments, the silo is extending along a central silo axis from the bottom side to an upper side of the silo.

In embodiments, the silo is oriented such that an angle ϕ between the central silo axis and an axis of gravity is in a range: 0°≤ϕ≤45°, preferably in a range 0°≤ ¢≤30°, more preferably in a range 0°≤ϕ≤10°.

In embodiments wherein the central reactor axis is essentially perpendicular with an axis of gravity, and wherein an angle β between the central silo axis and the central reactor axis is in a range: 45°≤β≤90°, preferably in a range 60°≤ϕ≤90°, more preferably in a range 80°≤ϕ≤90°.

In embodiments, wherein B=90°, the connecting tube is a straight tube oriented parallel with the central silo axis.

In embodiments wherein the central reactor axis is essentially parallel with an axis of gravity, and wherein an angle β between the central silo axis and the central reactor axis is in a range: 0°≤β≤45°, preferably in a range 0°≤ϕ≤30°, more preferably in a range 0°≤ϕ≤10°.

In embodiments, the silo comprises a stimulation device configured for stimulating a mass flow of solid reactant material within the silo, preferably the stimulation device is any of or a combination of: a rotation mechanism, a translation mechanism or a vibration mechanism. According to preferred embodiments, the stimulation device comprises one or more vibrating or rotating pins, plates or other mechanical bodies arranged inside the silo.

In embodiments, the connecting tube is extending from a first tube end to a second tube end, and wherein the first tube end is coupled to the bottom opening of the silo and the second tube end is coupled to the supply throughput of the chamber.

In embodiments, the device according to the present disclosure comprises a main gas transportation tube for further transporting the product gas extracted from the chamber.

In some embodiments, the device of the present disclosure comprises a mesh configured for avoiding solid reactant material to enter the plasma reactor.

In preferred embodiments, the device according to the present disclosure further comprises a port for extraction of depleted reactant material such as depleted carbon particles, preferably at a lower or lowest or bottom portion of the chamber, and preferably comprising a closing means or member for the port.

In preferred embodiments, the device according to the present disclosure further comprises an oxygen sensor arranged in the main gas transportation tube, arranged downstream from the reactant material, for measuring oxygen concentration of the product gas and a controller for controlling the flow of solid reactant material from the silo to the chamber and for controlling the removal of depleted reactant material from the chamber. The controller is preferably adapted for controlling the flow of solid reactant material from the silo to the chamber and removal of the depleted reactant material from the chamber based on only or at least an oxygen concentration in the main gas transportation tube downstream of the reactant material.

According to preferred embodiments, the controller is adapted or configured for triggering the flow of solid reactant material from the silo to the chamber and removal of depleted reactant material from the chamber when the oxygen concentration passes above a predetermined threshold value.

According to preferred embodiments, the controller is adapted or configured for triggering the flow of solid reactant material from the silo to the chamber and removal of depleted reactant material from the chamber in order to keep the oxygen concentration below a predetermined threshold value.

According to preferred embodiments, the controller is adapted or configured for triggering the flow of solid reactant material from the silo to the chamber and removal of depleted reactant material from the chamber in order to keep the oxygen concentration within a predetermined range.

According to preferred embodiments, the controller is further configured to control one or more or any combination of: the closing member of the port for extraction of reactant material (if present) and/or the stimulation device or stimulation means in the silo (if present) and/or the mixing and/or propeller means or device in the chamber (if present), preferably based on only or on at least the oxygen concentration measured by the oxygen sensor.

According to preferred embodiments, the chamber is configured for allowing the process of mixing the reactant material in the chamber.

According to preferred embodiments, comprises a mixing means or mixing device arranged and adapted for mixing reactant material such as carbon particles in the chamber. This provides the advantage that the reactant particles in the chamber are reshuffled and make a random change in orientation, possibly exposing another, less or not depleted portion of the respective reactant particles or pellets to the gas flow, improving performance of the device and extending the lifetime of the reactant particles.

According to preferred embodiments, the mixing device comprises at least one or a plurality of vibrating or rotating pins, plates or other mechanical bodies arranged in the chamber.

According to preferred embodiments, the mixing device comprises a screw or helical screw conveyer arranged in the chamber, preferably having a longitudinal axis parallel to a longitudinal axis of the chamber.

According to preferred embodiments, the chamber is mounted in a rotatable manner, preferably along an axis corresponding to a longitudinal axis of the chamber.

According to preferred embodiments, the process of mixing is continuous.

According to preferred embodiments, the process of mixing is according to a predetermined or measurement-controlled mixing time schedule. For instance, the mixing can occur once the oxygen concentration rises above a predetermined threshold value, for a predetermined time period, or for as long as the oxygen concentration has not gone substantially below said predetermined threshold value or below a second predetermined threshold value. Alternatively, the mixing can occur at predetermined regular time intervals for predetermined time periods. Still alternatively, mixing can occur at predetermined regular time intervals for time periods which are based on measurement of oxygen concentration. For instance, at regular time intervals, mixing may occur for as long as the respective oxygen concentration has not gone substantially below said predetermined threshold value or below a second predetermined threshold value.

In preferred embodiments, the device according to the present disclosure further comprises a means or device for propelling or driving the reactant material towards the port for extraction of depleted reactant material in the chamber. The means for propelling can for instance comprise a screw or helical screw conveyer arranged in the chamber. A longitudinal axis of said screw or helical screw conveyor preferably corresponds to a longitudinal axis of the chamber. According to preferred embodiments, the removal of the depleted reactant material occurs contemporaneously with the refill with fresh, undepleted reactant particles from the silo.

According to a second aspect of the present disclosure, a method for gas conversion is provided.

The method comprises:
providing a plasma reactor for generating a plasma, wherein the plasma reactor comprises one or more gas inlets configured for introducing a feed gas into the plasma reactor and a gas outlet for evacuating a gas flow of converted and unconverted feed gas from the plasma reactor,
providing a chamber fillable with a solid reactant material,
coupling the chamber to the plasma reactor such that a gas flow of converted and unconverted feed gas evacuated through the gas outlet of the plasma reactor is receivable in the chamber through an entrance opening of the chamber,
storing a stock of the solid reactant material in a silo,
using a connection tube for connecting a bottom opening of the silo with a supply throughput in the chamber for supplying reactant material,
positioning the silo and the connecting tube with respect to the chamber such that the solid reactant material can flow through the connecting tube from the silo to the chamber by a gravitational force or at least partly by a gravitational force,
filling the chamber with solid reactant material so as to form a fixed bed of solid reactant material within the chamber,
introducing a feed gas in the plasma reactor,
operating the plasma reactor for forming a plasma and generating a gas flow of converted and unconverted feed gas that is being received by the chamber such that the converted and/or unconverted feed gas can interact with the fixed bed of solid reactant material,
during operation of the plasma reactor, maintaining the silo connected with the chamber through the connecting tube such that if solid reactant material in the chamber is being depleted, a flow of solid reactant material from the silo to the chamber is induced so as to maintain the chamber filled with solid reactant material, and wherein the flow of reactant material from the silo to the chamber is induced by gravitational force or at least partly by gravitational force,
evacuating a product gas from the chamber.

In embodiments, the plasma reactor is a warm plasma reactor configured such that when in operation a plasma is generated wherein a gas temperature is equal or larger than 1000° Kelvin, preferably larger than 1500° Kelvin, more preferably larger than 2000° Kelvin, preferably the gas temperature is lower than 5000° Kelvin.

In embodiments, the plasma reactor is any of: a classical gliding arc plasma reactor, a rotating gliding arc plasma reactor, a vortex-stabilized gliding arc plasma reactor, a dual vortex plasma reactor, a microwave plasma reactor, an inductively coupled plasma reactor, a capacitively coupled plasma reactor, or an atmospheric pressure glow discharge plasma reactor.

In embodiments, the solid reactant material is selected from: a powder material, a grain material, a bulk material, a pellet material.

Features and embodiments described above for the first aspect are also intended to be disclosed for the second aspects, mutatis mutandis, and vice versa.

### SHORT DESCRIPTION OF THE DRAWINGS

These and further aspects of the present disclosure will be explained in greater detail by way of example and with reference to the accompanying drawings in which:

FIG. 1 schematically illustrates a cross-sectional view of a first embodiment of a device for gas conversion according to the present disclosure,

FIG. 2 schematically illustrates a cross-sectional view of a second embodiment of a device for gas conversion according to the present disclosure,

FIG. 3 schematically illustrates a cross-sectional view of a third embodiment of a device for gas conversion according to the present disclosure,

FIG. 4 schematically illustrates a cross-sectional view of a chamber according to the present disclosure for forming a fixed bed of solid reactant material,

FIG. 5a and FIG. 5b schematically illustrate a cross-sectional view of two embodiments of silos according to the present disclosure,

FIG. 6 illustrates oxygen concentration as function of time obtained with a device for gas conversion according to the present disclosure, curve A, and obtained with a prior art device without a chamber containing a carbon bed, curve B,

FIG. 7 schematically illustrates a cross-sectional view of an embodiment of a device for gas conversion according to the present disclosure wherein the plasma reactor is a 2D GA plasma reactor,

FIG. 8 schematically illustrates a cross-sectional view of an embodiment of a device for gas conversion according to the present disclosure wherein the plasma reactor is a microwave plasma reactor,

FIG. 9 schematically illustrates a cross-sectional view of an embodiment of a device for gas conversion according to the present disclosure wherein the plasma reactor is an APGD plasma reactor.

FIG. 10 schematically illustrates a fourth embodiment of the present disclosure, based on the third embodiment.

FIG. 11 is a graph providing data illustrating the advantages of the features added to the fourth embodiment with respect to the third embodiment.

FIG. 12 to FIG. 15 schematically illustrate features of preferred features of embodiments of the present disclosure.

The drawings of the figures are neither drawn to scale nor proportioned. Generally, identical components are denoted by the same reference numerals in the figures.

### DETAILED DESCRIPTION OF EMBODIMENTS

The present disclosure will be described in terms of specific embodiments, which are illustrative of the disclosure and not to be construed as limiting. It will be appreciated by persons skilled in the art that the present disclosure is not limited by what is particularly shown and/or described and that alternatives or modified embodiments could be developed in the light of the overall teaching of this disclosure. The drawings described are only schematic and are non-limiting.

Use of the verb “to comprise”, as well as the respective conjugations, does not exclude the presence of elements other than those stated. Use of the article “a”, “an” or “the” preceding an element does not exclude the presence of a plurality of such elements.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the disclosure described herein are capable of operation in other sequences than described or illustrated herein.

Reference throughout this specification to “one embodiment” or “an embodiment” means that a particular feature, structure or characteristic described in connection with the embodiments is included in one or more embodiment of the present disclosure. Thus, appearances of the phrases “in one embodiment” or “in an embodiment” in various places throughout this specification are not necessarily all referring to the same embodiment, but may.

Furthermore, the particular features, structures or characteristics may be combined in any suitable manner, as would be apparent to one ordinary skill in the art from this disclosure, in one or more embodiments.

When the word “essentially” is used in essentially parallel or essentially perpendicular, it has to be construed as being parallel or perpendicular within 1°.

When the word axis of gravity is used, it has to be construed as an axis that indicates a direction of earth gravitational force.

When the word “feed gas” is used it has to be construed as an input gas for the device for gas conversion. The feed gas comprises at least the gas to be converted, e.g. CO₂.

When the word “product gas” is used it has to be construed as an output gas of the device for gas conversion. The product gas comprising all gas species resulting from gas conversion within the device for gas conversion. The product gas also comprises feed gas that is not converted. For example, a product gas can comprise CO resulting from the conversion of CO₂.

### Device for Gas Conversion, General

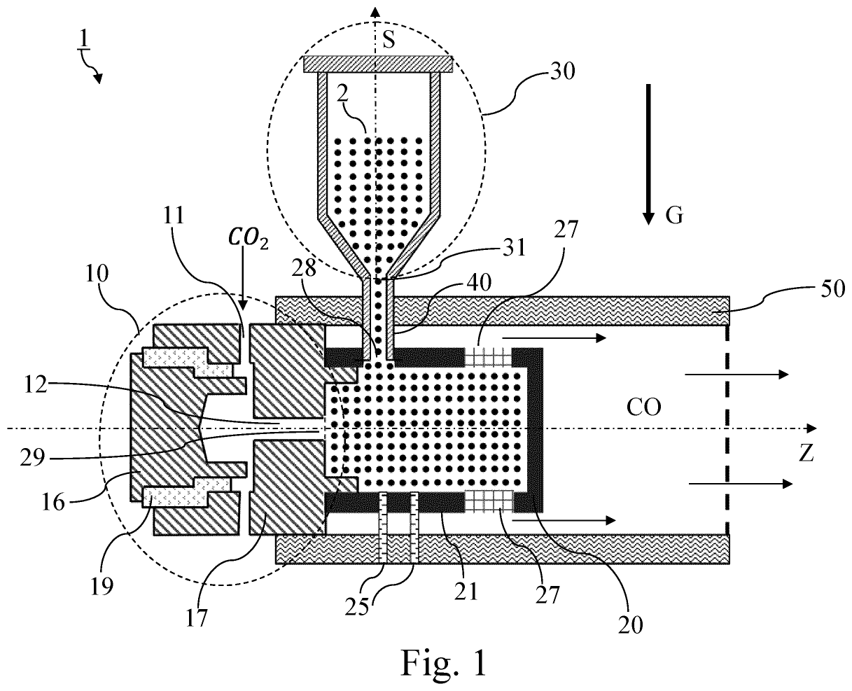

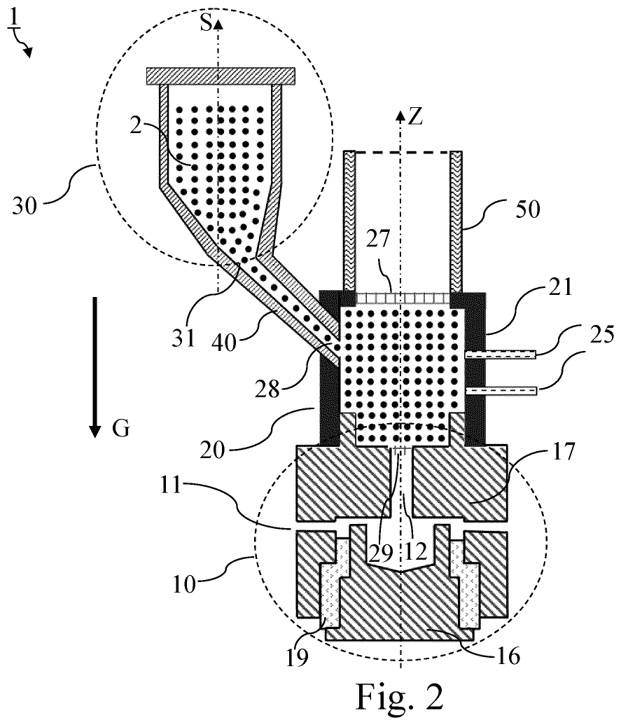

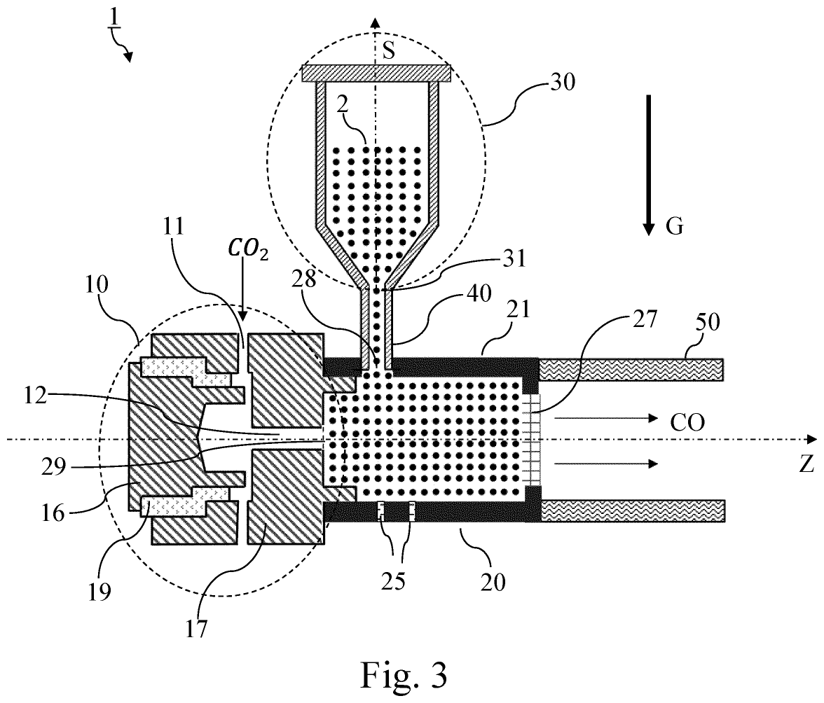

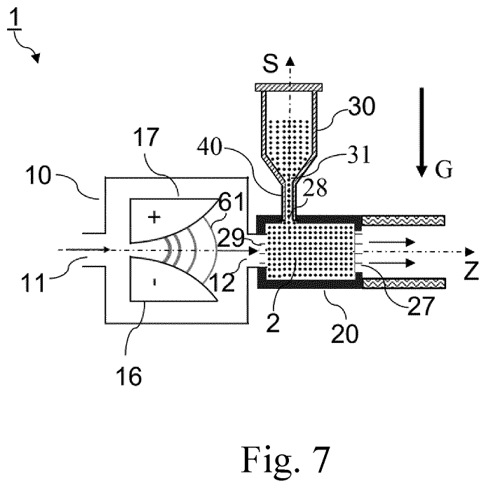

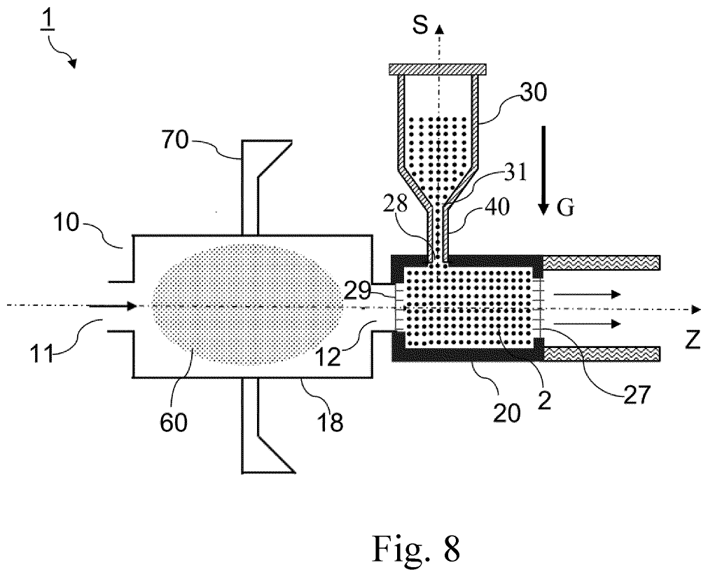

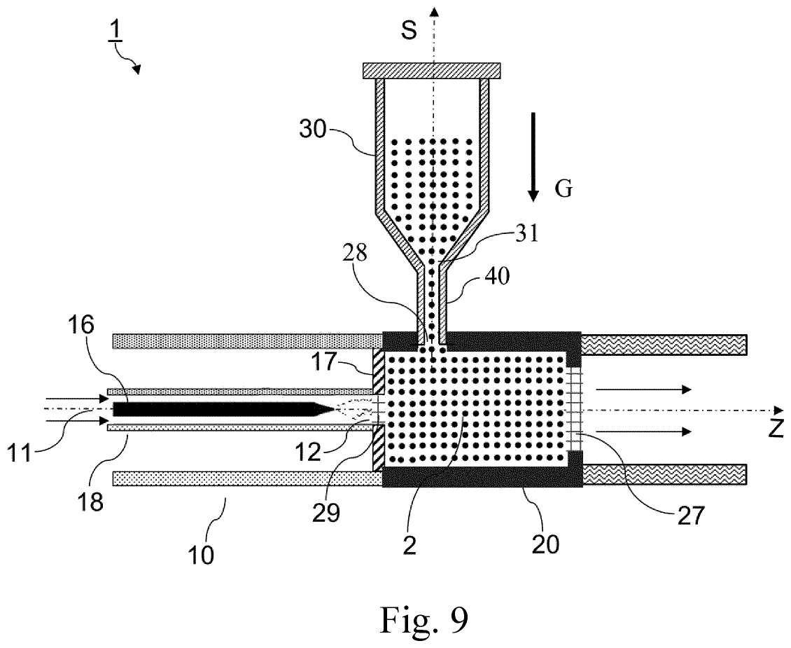

With reference to FIG. 1, FIG. 2, FIG. 3, FIG. 7, FIG. 8 and FIG. 9, cross-sections of exemplary embodiments of a device for gas conversion 1 according to the present disclosure are shown.

The device for gas conversion 1 according to the present disclosure comprises a plasma reactor 10 for generating a plasma. Typically, the plasma reactor comprises one or more gas inlets 11 configured for introducing a feed gas into the plasma reactor 10 and a gas outlet 12 for evacuating a gas flow of converted and unconverted feed gas from the plasma reactor 10.

The gas outlet has to be construed as an orifice or aperture located in a wall of the plasma reactor that is configured for extracting the converted and unconverted gas out of the plasma reactor. In embodiments, the gas outlet can for example have a circular cross-section.

The feed gas comprises the gas that needs conversion. For example, in embodiments the feed gas comprises CO₂ that needs to be converted to CO. In embodiments, the feed gas comprises besides the gas to be converted an additional carrier gas, for example an inert gas or another gas that might contribute to the conversion.

Converted feed gas has to be construed as decomposed feed gas. The converted feed gas comprises all species wherein the feed gas is decomposed as a result of the plasma interacting with the feed gas. The converted feed gas comprises for example gas molecules or atoms. As not all feed gas is converted in the plasma reactor, part of the gas leaving the plasma reactor is unconverted feed gas.

In embodiments, the plasma reactor is for example a plasma reactor configured for CO₂ conversion and hence in these embodiments the feed gas comprises at least CO₂. Converted feed gas leaving the plasma reactor through the gas outlet 12 comprises for example CO and O resulting from the splitting of CO₂ into CO and O, and the converted feed gas can further comprise for example O₂, formed by recombination of two O atoms.

Generally, as shown on FIG. 1 to FIG. 3 and FIG. 7 to FIG. 9, the plasma reactor 10 comprises a central reactor axis Z passing through the at least one gas outlet 12 of the plasma reactor 10. The wording passing through has to be construed as crossing or traversing. In embodiments wherein the gas outlet 12 has a circular cross-sectional shape, the central reactor axis Z is centrally passing through the gas outlet. Detailed embodiments of plasma reactors are further discussed below.

The device for gas conversion 1 of the present disclosure is characterized in that it further comprises a chamber 20 configured for receiving the gas flow of converted and unconverted feed gas evacuated through the gas outlet 12 of the plasma reactor 10.

Typically, the chamber 20 comprises a supply throughput 28 for filling the chamber with a solid reactant material 2 so as to form a fixed bed of solid reactant material within the chamber. In other words, the chamber 20 has to be construed as a reaction chamber wherein, when the plasma reactor is in operation, the converted and unconverted feed gas evacuated from the plasma reactor can react with the fixed bed of solid reactant material. In this way, a device for gas conversion is formed that is using two gas conversion stages: during a first stage, gas conversion takes place in the plasma reactor and during a second stage gas exiting the plasma reactor can further react with the solid reactant material in the chamber.

The chamber 20 is configured for holding a fixed bed of solid reactant material and hence it comprises at least walls for supporting or containing the solid reactant material.

As illustrated on FIG. 1 to FIG. 3 and FIG. 7 to FIG. 9, the chamber 20 comprises at least one gas exhaust window 27 for evacuation a product gas from the chamber.

The product gas has to be construed as the output gas of the device for gas conversion. The product gas comprises all gas species resulting from gas conversion in the plasma reactor combined with further gas interactions occurring in the chamber 20. Hence the product gas comprises gas resulting from an interaction of the converted and/or unconverted feed gas extracted from the plasma chamber with the fixed bed of solid reactant material 2. The product gas also comprises converted and/or unconverted feed gas extracted from the plasma reactor that did not further react with the fixed bed of reactant material.

As further illustrated on FIG. 1 to FIG. 3 and FIG. 7 to FIG. 9, the device for gas conversion 1 of the present disclosure further comprises a silo 30 for storing a stock of the solid reactant material 2. The silo comprises a bottom side having a bottom opening 31 for evacuating the solid reactant material from the silo and a connecting tube 40 is connecting the bottom opening 31 of the silo with the supply throughput 28 of the chamber. In this way, the solid reactant material can be transported through the connecting tube from the silo to the chamber.

Generally, as illustrated on FIG. 1 to FIG. 3 and FIG. 7 to FIG. 9, the connecting tube 40 is extending from a first tube end to a second tube end, and wherein the first tube end is coupled to the bottom opening 31 of the silo and the second tube end is coupled to the supply throughput 28 of the chamber.

In embodiments, the first tube end of the connecting tube 40 comprises an outer thread mating with an inner thread of the supply throughput 28 of the chamber such that the connecting tube can be removeably coupled to the chamber.

In embodiments, the second tube end of the connecting tube 40 is welded to the bottom opening 31 of the silo 30. In other embodiments, the second tube end comprises a thread configured for removeably coupling the connecting tube 40 to the bottom opening 31 of the silo 30.

The device of the present disclosure is characterized in that the silo 30 and the connecting tube 40 are configured such that the solid reactant material can flow from the silo 30 to the chamber 20 by a gravitational force or at least partly by a gravitational force. More precisely, when the device for gas conversion is in operation and solid reactant material is being depleted in the chamber, a flow of solid reactant material from the silo to the chamber is induced such that the chamber remains filled with solid reactant material. The flow of solid reactant material from the silo to the chamber is induced by a gravitational force or at least partly by a gravitational force.

Indeed, by defining the geometry and orientation of the silo with respect to the chamber, the flow from the silo to the chamber is induced by a gravitational force or at least partly by a gravitational force. In FIG. 1 to FIG. 3 and FIG. 7 to FIG. 9, an axis of gravitation G is shown, indicating a direction of gravitational force.

During operation of the device for gas conversion 1, the solid reactant material 2 in the chamber 20 is being depleted, and hence new solid reactant material needs to be continuously supplied. By continuously supplying reactant material from the silo 30 to the chamber 20 via the connecting tube 40, the device for gas conversion 1 can operate in a continuous mode without need to stop operations for refilling the plasma chamber 20 with solid reactant material 2.

Generally, the solid reactant material is selected from: a powder material, a grain material, a bulk material, a pellet material.

In embodiments, for example wherein the device for gas conversion is a device for CO₂ conversion, the solid reactant material is carbon, preferably in a form of carbon pellets or carbon grains. Examples of pellets are activated charcoal pellets.

In embodiments, the solid reactant material is biochar. Biochar is obtained from pyrolysis of biomass and is generally a quite cheap renewable energy source.

In embodiments, the device for gas conversion comprises a mesh configured for avoiding that solid reactant material contained in the chamber 20 enters the plasma reactor 10. Generally, the mesh is located at the gas outlet 12 of the plasma reactor 10. The mesh is for example made of metal, quartz, ceramic, or any other material suitable for withstanding the high temperatures of the plasma reactor. The mesh openings are designed to be smaller than the size of the particles or grains (or pellets) of solid reactant material. Depending on the reactor orientation and position with respect to the chamber, a mesh or a grid may not be required. This is for example the case for vertically inverted or horizontally mounted devices for gas conversion. A vertically inverted device for gas conversion has to be construed as a device wherein the chamber is positioned below the plasma reactor such that solid reactant particles in the chamber experience a gravitational force in a direction pointing away from the plasma reactor such that particles in the chamber cannot fall by gravitation through the gas outlet opening of the plasma reactor.

The device for gas conversion 1 generally comprises a main gas transportation tube 50 configured for further transporting the product gas after extraction of the product gas through the at least one gas exhaust window 27 of the chamber.

In embodiments as illustrated for example on FIG. 3, the transportation tube can be axially coupled to the chamber 20. This coupling can for example be made by screws or by welding.

In other embodiments, as illustrated for example on FIG. 1, an end portion of the transportation tube 50 is entirely surrounding the chamber 20 and the end portion of the transportation tube is coupled to the plasma reactor 10. Hence, in these embodiments the transportation tube 50 also forms at least partly an external exhaust body for the device for conversion. This coupling of the transportation tube to the plasma reactor can for example be made by screws or by welding. In this embodiment shown on FIG. 1, an opening is made through the transportation tube 50 such that the connecting tube 40 can pass through this opening and reach the chamber 20 after passing through the supply throughput 28 of the chamber. In the embodiment shown on FIG. 1, the end portion of the transportation tube is connected to the anode 17 of the plasma reactor.

### Chamber for Forming a Bed of Solid Reactant Material

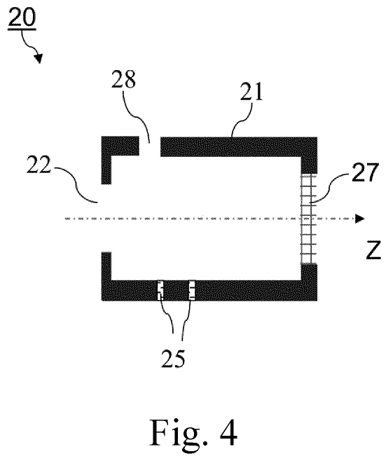

With reference to FIG. 4, a cross section of an example of an embodiment of a chamber 20 for forming a fixed bed of solid reactant material is schematically shown.

Typically, the chamber 20 is elongating along a central axis from a first end to a second end, and the first end comprises an axial entrance opening 22.

Generally, the central axis of the chamber corresponds to the central reactor axis Z of the plasma reactor. When the plasma reactor 10 and the chamber 20 are assembled for forming the device for gas conversion 1, the gas outlet 12 of the plasma reactor is facing the axial entrance opening of the chamber 20.

In FIG. 1 to FIG. 4 and FIG. 7 to FIG. 9, the walls of the chamber 20 are colored in black. The walls of the chamber 20 are preferably made of any of the following materials or combination thereof: stainless steel, copper, brass, quartz.

In embodiments, as schematically illustrated for example on FIG. 1 to FIG. 4, the walls of the chamber are plain walls. In other embodiments the walls can be mesh-type of walls forming a basket-type of chamber. The openings in the mesh of a basket-type of chamber are selected such that reactant material can be contained within the chamber.

In embodiments as shown on FIG. 4, the chamber 20 comprises a circumferential wall 21 extending between the first end and the second end, and the supply throughput 28 corresponds to an opening made through the circumferential wall 21.

In the embodiments shown on FIG. 2 to FIG. 4, the gas exhaust 27 is made through an axial end wall of the chamber. In other embodiments, as shown for example on FIG. 1, the gas exhaust 27, is made through the circumferential wall 21 of the chamber 20. The gas exhaust has to be construed as an opening in the chamber for evacuating the product gas.

In embodiments, the gas exhaust comprises a mesh configured to avoid that solid reactant material escapes from the chamber together with the product gas.

In embodiments, as shown on FIG. 1 to FIG. 4, the chamber 20 comprises one or more ports 25 configured for installing a thermocouple for measuring a temperature inside the chamber when the device for gas conversion is in operation. The temperature measurements allow to control or regulate the plasma reactor.

For coupling the chamber 20 to the plasma reactor 10, different options are possible.

In embodiments, the chamber 20 can for example be welded to the plasma reactor 10.

In other embodiments, the chamber 20 is removeably coupled to the plasma reactor 10. For example, the axial entrance opening 22 of the chamber 20 can comprise an inner thread mating with an outer thread of a portion of a body of the plasma reactor such that the chamber can be removeably screwed to the plasma reactor.

In embodiments, an electrode portion of the plasma reactor comprises an outer thread mating with the inner thread of the axial entrance opening 22 of the chamber, allowing to couple the chamber to the plasma reactor by screwing the chamber to the electrode 17.

In further embodiments the chamber 20 is screwed with screws to the plasma reactor 10.

### Silo, Exemplary Embodiments

The silo 30 for storing the reactant material can have various shapes. In embodiments, at least a portion of a circumferential wall of the silo has the shape of any of: a cone, a cylinder, a cuboid, a frustum, a pyramid, a prism, or any combination thereof.

Typically, the silo 30 is made of any of the following materials or a combination thereof: brass, copper, steel, glass, plastic.

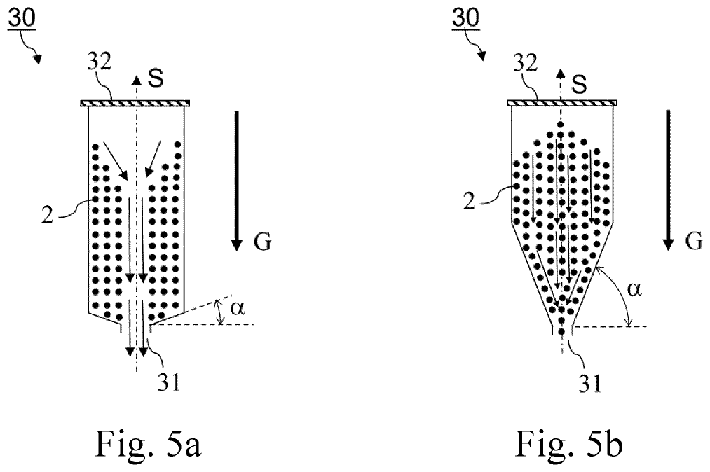

The silo 30 is oriented such that the solid particles experience a gravitational force and that the solid particles can fall out of the silo through the bottom opening 31 of the silo. For example, the central silo axis S that is extending from the bottom side to an upper side of the silo can be parallel with an axis of gravitation G, as schematically illustrated on FIG. 5a and FIG. 5b.

In order to make sure that a flow of solid reactant material can be induced by gravitational force from the silo to the chamber, the silo is oriented such that an angle ϕ between the central silo axis S and a axis of gravity G is in a range: 0°≤ϕ≤45°, preferably in a range 0°≤ϕ≤30°, more preferably in a range 0°≤ϕ≤10°. In the examples shown on FIG. 1 to FIG. 3 and FIG. 7 to FIG. 9, the angle ϕ is 0°, i.e. the central silo axis S of the silo is parallel with an axis of gravity G.

With reference to FIG. 5a and FIG. 5b examples of embodiments of a silo 30 according to the present disclosure are shown wherein the silo comprises a conical bottom portion. In these examples the central silo axis S is parallel with a gravitational axis G.

Depending on the geometry of the silo, a different type of flow of solid reactant material can be generated. In embodiments, as illustrated on FIG. 5a and FIG. 5b, the silo comprises a conical bottom portion having a cone angle α. Depending on the steepness of the cone, the flow of reactant material within the silo can be different. For a steep slope, i.e. large angle α, as shown on FIG. 5b, the solid material will fall down within the silo essentially layer by layer and the black arrows indicate a flow direction. On the other hand for a less steep flow, i.e. small angle α, or a silo without conical portion, a so-called funnel flow is generated within the silo wherein a funnel is created from top to bottom and particles fall down from top to bottom through the funnel. In FIG. 5a, the arrows indicate a direction of the particle flow. With a funnel flow type of silo, particles falling out of the silo through the bottom opening 31 are more mixed particles originating from different height levels in the silo. The angle α of the conical portion can be determined for example as function of a required mass flow rate of reactant material, the larger the angle α of the conical portion, the larger the mass flow rate.

In further embodiments, the silo 30 comprises a stimulation device configured for stimulating a mass flow of the reactant material within the silo. In embodiments, the stimulation device comprises a rotation mechanism such as a rotating screw or helical screw conveyor rotating inside the silo. In other embodiments, the stimulation device comprises a vibration mechanism such as a vibrating plate. In further embodiments the silo comprises a combination of a rotation and vibration mechanism. In further embodiments, the stimulation device comprises a translation mechanism. In other embodiments, the stimulation device comprises a moveable belt. In embodiments, the stimulation device can be a combination of any of a rotation, a translation or a vibration mechanism.

The stimulation device helps to bring the particles in the silo in a favorable position for falling down by gravitation through the bottom opening of the silo. Especially if the silo is partly empty, particles might be blocked inside the silo and it might be needed to move the particles inside the silo such that the particles are brought in front of the bottom opening of the silo and can fall down by gravitation.

In embodiments, the silo 30 comprises a lid 32 located at the upper side of the silo, as schematically illustrated on FIG. 5a and FIG. 5b. By removing the lid, the silo can be refilled with solid reactant material. In embodiments, the lid comprises a quartz window allowing to visually monitoring the amount of solid reactant material left in the silo.

### Device for Gas Conversion, Geometry

A number of exemplary embodiments of devices for plasma conversion wherein solid reactant material can flow from the silo 30 to the chamber 20 by a gravitational force or at least partly by a gravitational force are further discussed.

The orientation of the silo 30 with respect to the central reactor axis Z of the plasma reactor 10 can vary from embodiment to embodiment. Also, the orientation of the central reactor axis Z of the plasma reactor with respect to the axis of gravity G can vary from embodiment to embodiment.

A first geometry of the device for plasma conversion is a horizontal geometry, wherein the device is configured such that when in operation, the central reactor axis Z is essentially perpendicular with an axis of gravity G. This horizontal geometry corresponds to the geometry of the embodiments shown in FIG. 1, FIG. 3 and FIG. 7 to FIG. 9. As discussed above, essentially perpendicular has to be construed so that the central reactor axis Z of the plasma reactor and the axis of gravity G are perpendicular within 1°.

For embodiments of devices for gas conversion having such a horizontal geometry, the central silo axis S is forming an angle β with respect to the central reactor axis Z, and the angle β is typically in the following range: 45°≤β≤90°, preferably in a range 60°≤β≤90°, more preferably in a range 80°≤β≤90°. In this way, when the device for gas conversion is in operation, particles in the silo experience a gravitational force and fall through the bottom opening 31 of the silo and further via the connecting tube 40 towards the chamber 20.

In the embodiments shown on FIG. 1 and FIG. 3, the angle β is 90° and hence the central silo axis S of the silo is parallel with the axis of gravity G.

In embodiments, as further illustrated on FIG. 1 and FIG. 3, the connecting tube 40 is a straight tube that is oriented parallel with the central silo axis S. In this way, solid particles can fall by gravitational force from the bottom side of the silo directly via the straight tube into the chamber 20. In this way, as there is no bend in the connecting tube 40, the risk of particles being stuck in the connecting tube and thereby hindering the flow of particles from the silo to the chamber is reduced.

A second geometry of the device for gas conversion is a vertical geometry wherein the device is configured such that when in operation, the central reactor axis Z of the plasma reactor is essentially parallel with the axis of gravity G. This vertical geometry is illustrated with the embodiment shown on FIG. 2. Essentially parallel has to be construed as that the central reactor axis Z and the axis of gravity G are parallel within 1°.

For embodiments of devices for gas conversion having such a vertical geometry, the angle β between the central silo axis S of the silo and the central reactor axis Z of the plasma reactor is typically in the following range: 0°≤β≤45°, preferably in a range 0°≤β≤30°, more preferably in a range 0°≤β≤10° With such a geometry, particles in the silo experience a gravitational force and fall through the bottom opening 31 of the silo towards the chamber 20. The smaller the angle β, the better will the particles fall out of the silo. In the embodiment shown on FIG. 2, β=0°, and hence the central silo axis S of the silo is parallel with the central reactor axis Z of the plasma reactor.

In embodiments having such a vertical geometry, the connecting tube 40 comprises at least one straight tube portion wherein a central axis of the straight tube portion is oriented at an angle between 30° and 60° with respect to the central reactor axis Z.

### Plasma Reactor, Exemplary Embodiments

Various types of plasma reactors, e.g. proposed for CO₂ conversion, exist in the art and the present disclosure is not limited to a specific type of plasma reactor. Examples of different types of prior art plasma reactors are for example disclosed by Bogaerts and Centi in “Plasma technology for CO₂ conversion: A personal perspective on prospects and gaps.” Front. Energy Res., 8, 111 (2020).

The plasma reactors according to the present disclosure are also named atmospheric pressure plasma reactors as they typically operate at atmospheric pressure, but in principle they can operate in a pressure range between a few mbar to one bar and above. In its simplest form, a gas discharge plasma is created by applying an electric potential difference between two electrodes, positioned in a gas, further named feed gas, so that the feed gas can be either fully or partially ionized. The potential difference can in principle be direct current (DC), alternating current (AC), ranging from 50 Hz over kHz to MHz (radio-frequency; RF), or pulsed. In addition, the electrical energy can also be supplied in other ways, e.g., by a coil (inductively coupled plasma; ICP) or as microwaves (MW). Embodiments of different types of plasma reactors according to the present disclosure are further discussed below in more detail.

These plasma reactors are also named warm plasma reactors as these plasma reactors are configured such that when in operation a plasma is generated wherein a gas temperature is equal or larger than 1000° Kelvin, preferably larger than 1500° Kelvin, more preferably larger than 2000° Kelvin, preferably the gas temperature is lower than 5000° Kelvin. As will be discussed below, when the feed gas comprises for example CO₂, these high temperatures allow specific reactions to take place in the chamber filled with carbon pellets such as the transformation of oxygen into CO or the transformation of CO₂ into CO via a reverse Boudouard reaction.

Different type of plasma reactors exists that can generate such a warm plasma. In embodiments, the plasma reactor is for example any of the following non-limiting list of plasma reactor types: a classical gliding arc (GA) plasma reactor, a rotating gliding arc (RGA) plasma reactor, a vortex-stabilized gliding arc plasma reactor, a dual vortex plasma reactor, a microwave (MW) plasma reactor, an inductively coupled plasma (ICP) reactor, a capacitively coupled plasma (CCP) reactor, or an atmospheric pressure glow discharge plasma reactor (APGD).

A number of different types of plasma reactors for gas-conversion that are suitable for gas conversion according to the present disclosure wherein a chamber comprising a solid bed of reactant material is used, will be discussed in more detail.

### Gliding Arc Plasma Reactors

A first type of plasma reactor is a gliding arc, GA, plasma reactor. The GA discharge is a transient type of arc discharge. A distinction can be made between a two-dimensional, 2D, GA and a three-dimensional, 3D, GA plasma reactor. The 2D GA is also known as the classical gliding arc plasma reactor.

What these GA plasma reactors have in common is that they comprise a first electrode, a second electrode electrically insulated of the first electrode, and a power supply configured for maintaining a high-voltage between the first and second electrode. The high-voltage is typically in the kV range.

In a classical 2D GA plasma reactor, as illustrated on FIG. 7, a discharge arc 61 is formed between two flat diverging electrodes 16,17. The arc is initiated at the shortest interelectrode distance, and under influence of a gas blast, which flows along the electrodes, the arc 61 “glides” towards larger interelectrode distance, until it extinguishes and a new arc is created at the shortest interelectrode distance. As illustrated in FIG. 7, the plasma chamber 20 coloured in black on FIG. 7, comprises a fixed bed of solid reactant material 2 and is coupled to the 2D GA plasma reactor 10. The arrows illustrate the gas flow through the reactor: the feed gas enters axially through the gas inlet 11 of the plasma reactor 10 and the gas leaves axially the plasma reactor through the outlet opening 12 wherein it is received in the chamber 20. During operation of the GA plasma reactor, the silo 30 provides for a continuous supply of reactant material. The product gas finally leaves the chamber 20 through the gas exhaust window 27 in the chamber 20.

Examples of a 3D GA discharge plasma reactor are a 3D gliding arc plasmatron, GAP, and a rotating gliding arc, RGA, reactor. A type of 3D plasma reactors are also known as vortex-stabilized plasma reactors. A distinction can be made between forward vortex flow, FVF, plasma reactors, and reverse vortex flow, RVF, plasma reactors.

With reference to FIG. 1 to FIG. 3, a device for gas conversion is shown wherein the plasma reactor is a 3D gliding arc plasmatron, more precisely a reverse vortex flow plasmatron. The 3D GAP 10 comprises a first electrode 16, being the cathode, and a second electrode 17 being the anode. Both electrodes are for example made of stainless steel and the first and second electrode are connected to a DC current source type power supply and to the ground, respectively. The electrodes are insulated by an insulator 19, such as teflon.

With a GAP reactor 10, the feed gas, e.g. CO₂, is introduced as a swirling gas flow with respect to the central reactor axis Z, which causes an arc to start gliding. The gas outlet 12 of the GAP 10 is a central opening through the second anode electrode 17.

In a reverse vortex flow plasmatron, the gas first flows in an outer vortex in a direction away from the gas outlet 12 and subsequently the gas will flow back in a reverse inner vortex with smaller diameter in a direction towards the gas outlet 12. Hence, when an arc is formed by the plasmatron 10, the arc is pushed away from the reactor thanks to the reverse vortex flow through the opening in the anode, directly towards the carbon bed.

A further example of a 3D GA plasma reactor is a so-called dual vortex plasmatron, DVP, known in the art. In this embodiment, the first and second electrode are wall portions of the plasma reactor that are electrically separated by an electrical insulator, and wherein an arc is elongated in two directions. The dual vortex plasmatron 10 comprises a first and a second gas outlet located on opposite sides and a first and second chamber filled with reactant material can be coupled to respectively the first and second gas outlet.

### Microwave Plasma Reactors

A second type of plasma reactor is a microwave, MW, plasma reactor wherein the plasma is created by applying microwaves, i.e., electromagnetic radiation with a frequency between 300 MHz and 10 GHz, to a gas, without using electrodes. There are different types of MW plasmas, such as cavity induced plasmas, free expanding atmospheric plasma torches, electron cyclotron resonance plasmas and surface wave discharges.

An example of an embodiment of device for gas conversion 1 comprising a MW plasma reactor 10 and a chamber 20 with a carbon bed 2 is shown in FIG. 8. The plasma reactor 10 typically comprises a quartz tube 18 having a gas inlet 11, e.g. an axial gas inlet as shown on FIG. 8. The quartz tube 18 is transparent to MW radiation and is intersecting with a rectangular waveguide 70. Microwave power transferred to the microwave plasma reactor 10 initiates a plasma 60 within the quartz tube. The chamber 20 comprising the carbon bed with reactant material 2, is coupled with the MW plasma reactor 10 and the converted and unconverted feed gas leaves the MW plasma reactor through the gas outlet 12 of the quartz tube and enters the chamber 20. During operation of the MW plasma reactor, the silo 30 provides for a continuous supply of reactant material.

### Atmospheric Pressure Glow Discharge Reactors

A third type of plasma reactors are so-called atmospheric pressure glow discharges, APGD, reactors. A device 1 for gas conversion comprising a basic APGD reactor is schematically illustrated in FIG. 9. The APGD reactor comprises a pin-type cathode 16 extending along the central reactor axis Z and an axial plate having a hole is forming the anode 17. The APGD generally comprises a quartz tube 18 wherein the feed gas enters axially via the gas inlet. The converted and unconverted gas flows out of the quartz tube 18 via the gas outlet 12 and enters the chamber 20 comprising the bed with solid reactant material 2. During operation of the APGD plasma reactor, the silo 30 provides for a continuous supply of reactant material 2.

### Method for Gas Conversion

According to a further aspect of the invention, a method for gas conversion is provided. In embodiments, the method is a method for converting CO₂ into CO, hence wherein the feed gas comprises CO₂ and wherein the product gas comprises CO.

The method for gas conversion according the present disclosure comprises steps of:
providing a plasma reactor 10 for generating a plasma, wherein the plasma reactor comprises one or more gas inlets 11 configured for introducing a feed gas into the plasma reactor 10 and a gas outlet 12 for evacuating a gas flow of converted and unconverted feed gas from the plasma reactor 10,
providing a chamber 20 fillable with a solid reactant material (2),
coupling the chamber 20 to the plasma reactor such that a gas flow of converted and unconverted feed gas evacuated through the gas outlet 12 of the plasma reactor 10 is receivable in the chamber through an entrance opening of the chamber,
storing a stock of the solid reactant material in a silo 30,
using a connection tube 40 for connecting a bottom opening 31 of the silo with a supply throughput 28 in the chamber 20 for supplying reactant material,
positioning the silo 30 and the connecting tube 40 with respect to the chamber 20 such that the solid reactant material can flow through the connecting tube 40 from the silo 30 to the chamber 20 by a gravitational force or at least partly by a gravitational force,
filling the chamber 30 with solid reactant material so as to form a fixed bed of solid reactant material within the chamber,
introducing a feed gas in the plasma reactor 10,
operating the plasma reactor for forming a plasma and generating a gas flow of converted and unconverted feed gas that is received by the chamber 20 such that the converted and/or unconverted feed gas can interact with the fixed bed of solid reactant material,
during operation of the plasma reactor, maintaining the silo 30 connected with the chamber through the connecting tube 40 such that if solid reactant material in the chamber is being depleted, a flow of solid reactant material from the silo to the chamber is induced so as to maintain the chamber 30 filled with reactant material, and wherein the flow of reactant material from the silo to the chamber is induced by gravitational force or at least partly by gravitational force,
evacuating a product gas from the chamber.

In embodiments for conversion of CO₂ into CO the feed gas comprises at least CO₂ and the solid reactant material is carbon, preferably, as discussed above, in a form of carbon pellets or carbon grains.

In embodiments for conversion of CO₂ into CO, when the plasma reactor is in operation, the converted feed gas received by the chamber comprises besides CO molecules also O atoms and/or O₂ molecules, and wherein the O atoms and/or O₂ molecules when received in the chamber react with the solid carbon C₍ₛ₎ of the carbon bed through the following reactions:

O+C₍ₛ₎→CO

O₂+2 C₍ₛ₎→2 CO

In this way, by providing a flow of carbon reactant material from the silo to the chamber during operation of the plasma reactor, O and/or O₂ are continuously transformed into CO such that the final product gas extracted from the chamber is essentially oxygen-free and the final product gas is essentially pure CO. This avoids large separation costs to subsequentially process the product gas and e.g. remove oxygen from CO.

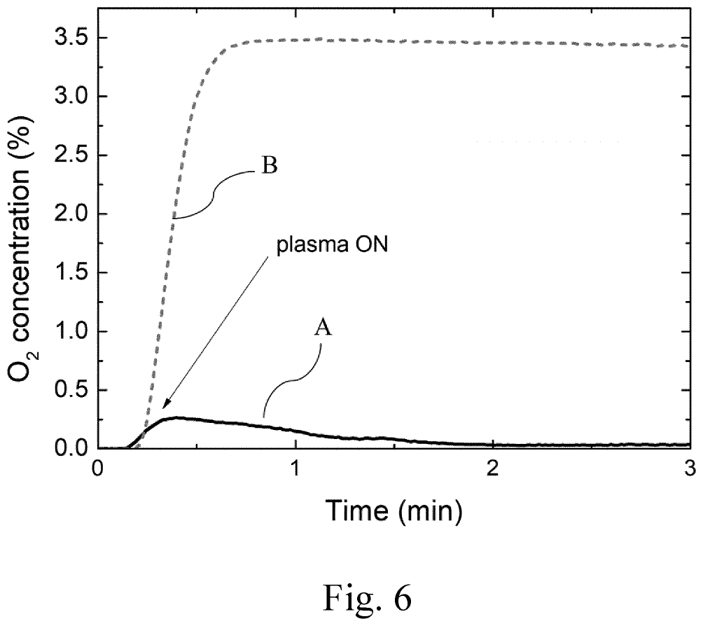

The oxygen concentration observed in the extracted product gas is plotted as function of time in FIG. 6. The full line A is obtained with the device for gas conversion according to the present disclosure, i.e. comprising a chamber filled with a fixed carbon bed, and the dotted line B is obtained without using the chamber containing a carbon bed. When no chamber with a fixed bed of carbon is used, after ignition of the plasma, a strong increase of the oxygen concentration is immediately observed and concentration levels up to 3.5% are reached, as illustrated with curve B on FIG. 6. In contrast, when using a device according to the present disclosure comprising a chamber with a fixed bed of carbon, after ignition of the plasma, only a small transient raise of the oxygen level is observed until a maximum is reached followed by a decrease of the oxygen level because of its reaction with solid carbon. As illustrated with curve A on FIG. 6, with the device and method according to the present disclosure, the oxygen concentration levels in the product are kept below 0.5%. Hence, this is a strong reduction when compared with the prior art standard plasma reactor without the chamber with the carbon bed, where in this example, the oxygen concentration reaches levels up to about 3.5%.

In embodiments for conversion of CO₂ into CO, when the plasma reactor is in operation, and unconverted CO₂ gas is received in the chamber, the CO₂ gas reacts with the carbon bed through a reverse Boudouard reaction:

CO₂+C₍ₛ₎→2 CO

Indeed, when the plasma reactor 10 is in operation, the plasma will, through the gas outlet of the plasma reactor, come into contact with the carbon bed and hence the carbon bed benefits from the high temperatures of the plasma, which depending on the type of plasma reactor can be as high as 3000° K. These high temperatures promote the occurrence of the reverse Boudouard reaction which requires temperatures of at least 700° K.

Generally, the plasma reactor generates also a plasma afterglow that extends mainly along the central reactor axis of the plasma chamber and further contributes for providing optimum temperature conditions for the reverse Boudouard reaction to occur.

It is observed that impurities in the carbon reactant material can have a detrimental effect on the gas conversion. For example, hydrogen molecules resulting from impurities can lead to the formation of water molecules.

Therefore, in embodiments, the method for gas conversion comprises a further step of pre-treating the carbon, i.e. before storing the carbon in the silo, in order to remove hydrogen-containing and/or oxygen-containing functional groups from the carbon.

In embodiments, pre-treating of carbon comprises placing the carbon in a furnace filled with an inert gas.

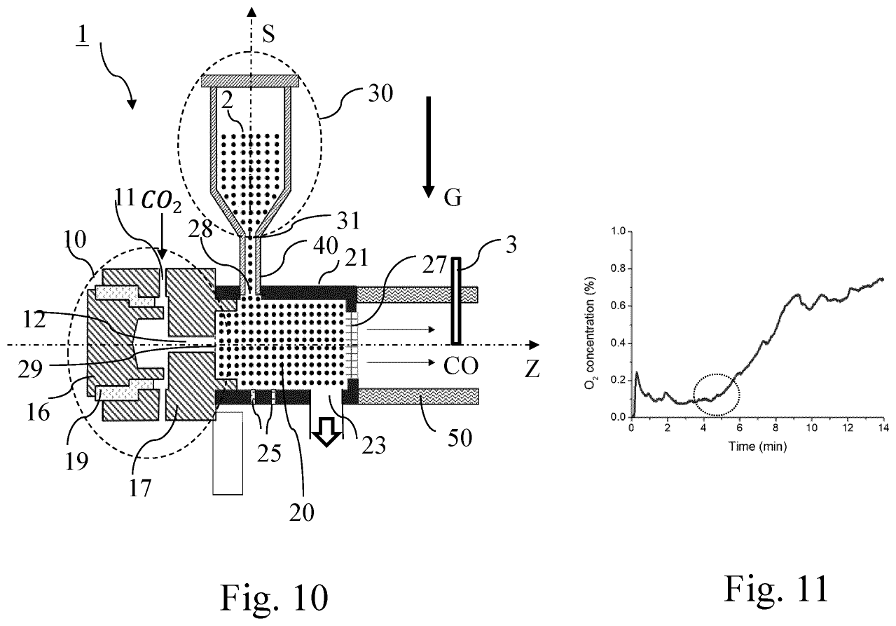

FIG. 10 schematically illustrates a fourth embodiment of the present disclosure, similar to the third embodiment. It differs from the third embodiment in that a port 23 for extraction of depleted reactant material 2 has explicitly been provided. The port 23 is arranged at a lower or lowest, e.g. bottom part or region of the chamber 20. Optionally it can comprise a closing member or gate that can be opened gradually or between an open and closed position. Further, it comprises an oxygen sensor 3 for measuring the oxygen concentration of the product gas downstream of the solid reactant material, preferably in the main gas transportation tube 50. The sensor has to be positioned far enough from the chamber 20 so that the gas temperature has cooled down and is comprised within an accepted temperature range during operation of the device. The oxygen sensor 3 generates oxygen level measurements. The controller uses at least these measurements to control the flow of reactant material 2 from silo 30 to chamber 20 and the removal of depleted reactant material 2 from the chamber 20 through the port 23 for extraction, preferably by controlling one, a selection of or all of: the stimulation means 33, the mixing means 241, the port 23, the propelling means 242.

FIG. 11 is a graph providing data illustrating the advantages of the features added to the fourth embodiment with respect to the third embodiment. It illustrates a typical evolution of the oxygen concentration in the product gas (Y-axis) over time (X-axis). It shows that after a certain time period in which the oxygen concentration is relatively stable and constant, the concentration starts increasing quickly (area encircled by dotted line). This is due to depletion and/or saturation of active sites of the reactant material 2 in the chamber 20. When the oxygen concentration is too high, the functioning of the gas conversion device 1 is jeopardised. The use of an oxygen sensor 3, which communicates with a controller, which on its turn controls the described stimulation means 33 and/or the mixing means 241 and/or the port 23 and/or the propelling means 242 allows the replacement of the depleted reactant material with new reactant material coming from the silo 30. As a result, the oxygen concentration in the product gas downstream of the reactant material can be controlled.

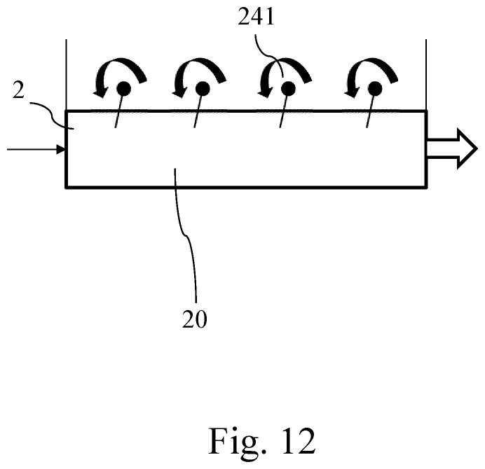

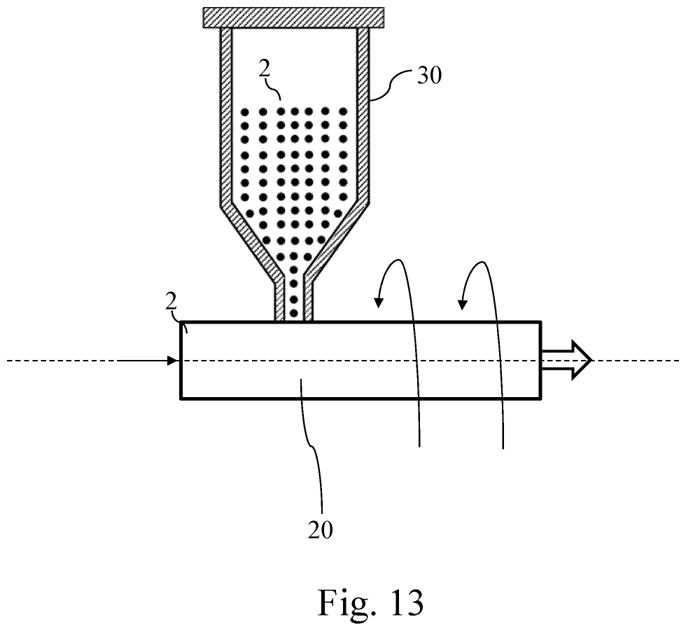

FIG. 12 and FIG. 13 schematically illustrate preferred features of embodiments of the present disclosure.

FIG. 12 schematically illustrates embodiments wherein the chamber 20 comprises a mixing means or mixing device 241 arranged and adapted for mixing reactant material 2 such as carbon particles in the chamber 20. Those can be applied with all preferred embodiments. The mixing device comprises at least one or a plurality of vibrating or rotating pins 241 arranged in the chamber 20.

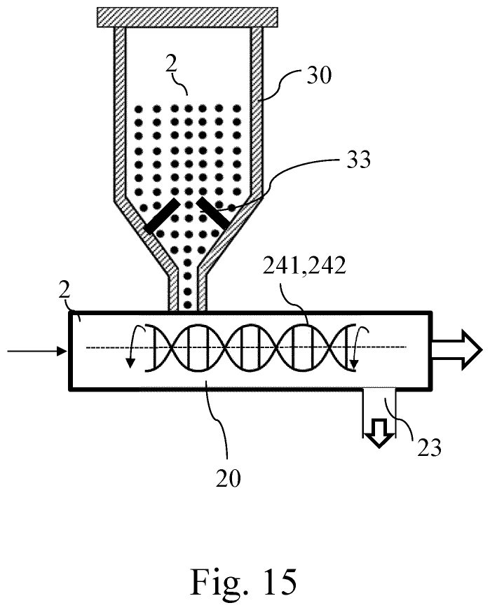

Alternatively, or in combination therewith, the mixing device 241 comprises a screw or helical screw conveyer 241, 242 arranged in the chamber, preferably having a longitudinal axis parallel to the axis of the chamber. Such a screw or helical screw conveyor typically has a propeller function as described in relation with the propeller means 242 in FIG. 15.

FIG. 13 shows that the chamber is mounted in a rotatable manner, preferably along an axis corresponding to a longitudinal axis of the chamber. By rotating the chamber the reactant can be mixed.

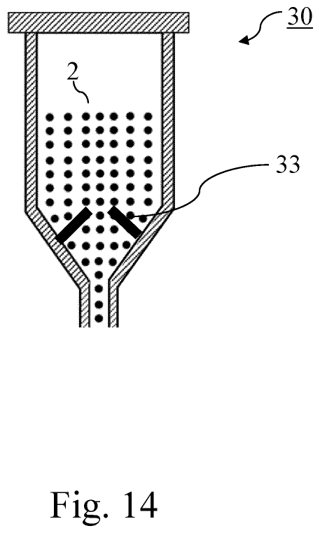

FIG. 14 illustrates a preferred embodiment of a silo 30 as it can be applied with all preferred embodiments, which comprises a stimulation device 33 which comprises one or more vibrating or rotating pins arranged inside the silo 30. The one or more vibrating or rotating pins 33 can be actuated by state of the art driving mechanism as for instance mechanically or electronically or electromagnetically.

FIG. 15 schematically illustrates components of preferred embodiments of the present disclosure, that can be applied with all preferred embodiments. A means or device 242 for propelling the depleted reactant material 2 towards the port 23 for extraction of depleted reactant material 2 has been provided. The means for propelling 242 comprises a screw or helical screw conveyer arranged in the chamber 20. In some embodiments the means for propelling 242 can correspond to the means for mixing 241. The functioning of the means for propelling 242 and mixing 241 is preferably controlled by a controller. The controller preferably controls at least the device for mixing 241 and/or propelling 242 based on at least the oxygen concentration (oxygen measurements) provided by an oxygen sensor 3 arranged in the main gas transportation tube 50 downstream from the reactant material 2.

In summary, according to the present disclosure, the following items could for instance be claimed:

1. A device for gas conversion comprising: a) a plasma reactor for generating a plasma, said plasma reactor comprising one or more gas inlets configured for introducing a feed gas into the plasma reactor, and a gas outlet for evacuating a gas flow of converted and unconverted feed gas from the plasma reactor, characterized in that the device further comprises b) a chamber coupled to the plasma reactor, wherein the chamber is configured for holding a fixed bed of solid reactant material and for receiving said gas flow of converted and unconverted feed gas evacuated through the gas outlet of the plasma reactor, and wherein the chamber further comprises: a supply throughput for filling the chamber with the solid reactant material so as to form the fixed bed of solid reactant material and at least one gas exhaust window for extracting a product gas from the chamber, c) a silo for storing a stock of the solid reactant material, and wherein the silo comprises a bottom side having a bottom opening for evacuating solid reactant material from the silo, and d) a connecting tube connecting the bottom opening of the silo with the supply throughput of the chamber, and wherein the silo and the connecting tube are configured such that, when the device is in operation and solid reactant material is being depleted in the chamber, a flow of solid reactant material from the silo to the chamber is induced so as to maintain the chamber filled with solid reactant material, and wherein said flow of solid reactant material from the silo to the chamber is induced by a gravitational force or at least partly by a gravitational force.

2. The device of item 1, wherein the plasma reactor comprises a central reactor axis Z passing through said at least one gas outlet of the plasma reactor, and wherein said chamber is elongating along said central reactor axis from a first end to a second end.

3. The device of item 2, wherein the first end of the chamber comprises an axial entrance opening, and wherein the gas outlet of the plasma reactor is facing said axial entrance opening of the chamber.

4. The device of item 2 or item 3, wherein the chamber comprises at least a circumferential wall extending between the first end and the second end, and wherein the supply throughput is made through the circumferential wall, preferably said circumferential wall is made of any of the following materials or combination thereof: stainless steel, copper, brass, quartz.

5. The device according to item 4, wherein said at least one gas exhaust is made through the circumferential wall of the chamber, or alternatively wherein said at least one gas exhaust is made through an axial end wall at the end of the chamber.

6. The device of any of items 2 to 5, wherein said silo is extending along a central silo axis S from the bottom side to an upper side of the silo, and wherein said central silo axis S is essentially perpendicular to the central reactor axis Z.

7. The device of item 6 wherein said connecting tube is a straight tube oriented parallel with the central silo axis S.

8. The device of any of items 2 to 5, wherein said silo is extending along a central silo axis S from the bottom side to an upper side of the silo, and wherein said central silo axis S is essentially parallel with the central reactor axis Z of the plasma reactor.

9. The device of item 8, wherein said connecting tube comprises at least one straight tube portion wherein a central axis of the straight tube portion is oriented at an angle between 30° and 60° with respect to said central reactor axis Z.

10. The device of any of items 1 to 5, wherein said silo is extending along a central silo axis S from the bottom side to an upper side of the silo and wherein the silo is oriented such that an angle ϕ between said central silo axis S and an axis of gravity (G) is in a range: 0°≤ϕ≤45°, preferably in a range 0°≤ϕ≤30°, more preferably in a range 0°≤ϕ≤10°.

11. The device of any of items 2 to 5, wherein said device is configured such that when in operation said central reactor axis Z is essentially perpendicular with an axis of gravity G, and wherein said silo is extending along a central silo axis S from the bottom side to an upper side of the silo, and wherein an angle β between said central silo axis S and said central reactor axis Z is in a range: 45°≤β≤90°, preferably in a range 60°≤β≤90°, more preferably in a range 80°≤β≤90°.

12. The device of any of items 2 to 5, wherein said device is configured such that when in operation said central reactor axis Z is essentially parallel with an axis of gravity G, and wherein said silo is extending along a central silo axis S from the bottom side to an upper side of the silo, and wherein an angle β between said central silo axis S and said central reactor axis Z is in a range: 0°≤β≤45°, preferably in a range 0°≤β≤30°, more preferably in a range 0°≤β≤10°.

13. The device of any of previous items, wherein the chamber comprises one or more ports configured for installing a thermocouple for measuring a temperature inside the chamber.

14. The device of any of previous items, comprising a main gas transportation tube for further transporting said product gas extracted from the chamber.

15. The device of any of previous items, comprising a mesh configured for avoiding solid reactant material to enter the plasma reactor.

16. The device of any of previous items, wherein a portion of a circumferential wall of the silo has the shape of any of: a cone, a cylinder, a cuboid, a frustum, a pyramid, a prism, or any combination thereof.

17. The device of any of previous items, wherein said connecting tube is extending from a first tube end to a second tube end, and wherein the first tube end is coupled to the bottom opening of the silo and the second tube end is coupled to the supply throughput of the chamber.

18. The device of any of previous items, wherein the silo comprises a stimulation device configured for stimulating a mass flow of solid reactant material within the silo, preferably the stimulation device is any of or a combination of: a rotation mechanism, a translation mechanism or a vibration mechanism.

19. The device according to item 18, wherein said stimulation device comprises one or more vibrating or rotating pins arranged inside the silo.

20. The device of any of previous items, wherein the silo is made of any of the following material or a combination thereof: brass, copper, steel, glass, plastic.

21. The device of any of previous items, wherein said plasma reactor comprises at least a first electrode and a second electrode electrically insulated from the first electrode, and wherein a wall opening made through said second electrode is forming said gas outlet of the plasma chamber, preferably said first electrode is a high-voltage cathode and said second electrode is a grounded anode.

22. The device of any of the previous items, further comprising a port for extraction of depleted reactant material such as depleted carbon particles, preferably at a lower or bottom portion of the chamber, and preferably comprising a closing means or member for said port.

23. The device of any of the previous items, further comprising an oxygen sensor arranged in said main gas transportation tube for measuring oxygen concentration and a controller for controlling said flow of solid reactant material from the silo to the chamber and for controlling the removal of depleted reactant material from the chamber, said controller preferably being adapted for controlling said flow of solid reactant material from the silo to the chamber and removal of said depleted reactant material from the chamber based on at least an oxygen concentration in said main gas transportation tube.

24. The device according to item 23, wherein said controller is adapted for triggering the flow of solid reactant material from the silo to the chamber and removal of depleted reactant material from the chamber when said oxygen concentration passes above a predetermined threshold value.

25. The device according to item 23, wherein said controller is adapted for triggering the flow of solid reactant material from the silo to the chamber and removal of depleted reactant material from the chamber in order to keep said oxygen concentration within a predetermined range or below a predetermined threshold value.

26. The device according to any of the previous items, wherein said chamber is configured for allowing the process of mixing the reactant material in said chamber.

27. The device according to item 26, wherein the chamber comprises a mixing means or mixing device arranged and adapted for mixing reactant material such as carbon particles in the chamber.

28. The device according to item 27, wherein said mixing device comprises at least one or a plurality of vibrating or rotating pins arranged in said chamber.

29. The device according to item 27, wherein said mixing device comprises a screw or helical screw conveyer arranged in the chamber, preferably having a longitudinal axis parallel to the axis of the chamber.

30. The device according to item 27, wherein the chamber is mounted in a rotatable manner, preferably along an axis corresponding to a longitudinal axis of the chamber.

31. The device according to any of items 26 to 30, wherein the process of mixing is continuous.

32. The device according to any of items 26 to 30, wherein the process of mixing is according to a predetermined or measurement-controlled mixing time schedule.

33. A device according to any of the previous items 22 to 32, further comprising a means or device for propelling said reactant material towards said port for extraction of depleted reactant material in said chamber.

34. A device according to item 33, wherein said means for propelling comprises a screw or helical screw conveyer arranged in the chamber.

35. A method for gas conversion comprising: providing a plasma reactor for generating a plasma, wherein the plasma reactor comprises one or more gas inlets configured for introducing a feed gas into the plasma reactor and a gas outlet for evacuating a gas flow of converted and unconverted feed gas from the plasma reactor, providing a chamber fillable with a solid reactant material, coupling the chamber to the plasma reactor such that a gas flow of converted and unconverted feed gas evacuated through the gas outlet of the plasma reactor is receivable in the chamber through an entrance opening of the chamber, storing a stock of the solid reactant material in a silo, using a connection tube for connecting a bottom opening of the silo with a supply throughput in the chamber for supplying reactant material, positioning the silo and the connecting tube with respect to the chamber such that the solid reactant material can flow through the connecting tube from the silo to the chamber by a gravitational force or at least partly by a gravitational force, filling the chamber with solid reactant material so as to form a fixed bed of solid reactant material within the chamber, introducing a feed gas in the plasma reactor, operating the plasma reactor for forming a plasma and generating a gas flow of converted and unconverted feed gas that is received by the chamber such that the converted and/or unconverted feed gas can interact with the fixed bed of solid reactant material, during operation of the plasma reactor, maintaining the silo connected with the chamber through the connecting tube such that if solid reactant material in the chamber is being depleted, a flow of solid reactant material from the silo to the chamber is induced so as to maintain the chamber filled with solid reactant material, and wherein said flow of reactant material from the silo to the chamber is induced by gravitational force or at least partly by gravitational force, evacuating a product gas from the chamber.

36. The method of item 35, wherein the reactant material is carbon and wherein the method further comprises: before storing the carbon in the silo, pre-treating the carbon to remove hydrogen-containing and/or oxygen-containing functional groups from the carbon, preferably said pre-treating comprises placing the carbon in a furnace filled with an inert gas.

37. The device of any of items 1 to 34 or the method of item 35 or item 36, wherein the solid reactant material is selected from: a powder material, a grain material, a bulk material, a pellet material.

38. The device of any of items 1 to 34 or the method of item 35 or item 36, wherein the solid reactant material is carbon, preferably in a form of carbon pellets or carbon grains, and wherein the feed gas comprises at least CO₂, and wherein the product gas evacuated from the chamber comprise at least CO.

39. The device of any of items 1 to 34 or the method of any of items 35 to 38, wherein said plasma reactor is any of: a classical gliding arc plasma reactor, a rotating gliding arc plasma reactor, a vortex-stabilized gliding arc plasma reactor, a dual vortex plasma reactor, a microwave plasma reactor, an inductively coupled plasma (ICP) reactor, a capacitively coupled plasma (CCP) reactor, or an atmospheric pressure glow discharge plasma reactor.

40. The device of any of items 1 to 34 or the method of any of items 35 to 38, wherein said plasma reactor is a warm plasma reactor configured such that when in operation a plasma is generated wherein a gas temperature is equal or larger than 1000° Kelvin, preferably larger than 1500° Kelvin, more preferably larger than 2000° Kelvin, preferably said gas temperature is lower than 5000° Kelvin.

Reference numbers

| | |
|---|---|
| 1 | Device for gas conversion |
| 2 | Solid reactant material |
| 3 | Oxygen sensor |
| 10 | Plasma reactor |
| 11 | Gas inlet of plasma reactor |
| 12 | Gas outlet of plasma reactor |
| 16 | First electrode |
| 17 | Second electrode |
| 18 | Quartz tube |
| 19 | Insulator |
| 20 | Chamber |
| 21 | Circumferential wall of chamber |
| 22 | Axial entrance opening of chamber |
| 23 | Port for extraction of reactant particles |
| 241 | Mixing device or means |
| 242 | Propelling device or means |
| 25 | Port for installing thermocouple |
| 27 | Gas exhaust window |
| 28 | Supply throughput |
| 29 | Mesh |
| 30 | Silo |
| 31 | Bottom opening of silo |
| 32 | Lid of silo |
| 33 | Vibrating or rotating pins |
| 40 | Connecting tube |
| 50 | Main gas transportation tube |
| 60 | Plasma |
| 61 | Arc |
| 70 | Wave guide |
| S | Central silo axis |
| Z | Central reactor axis |

1. A device for gas conversion comprising:
a plasma reactor for generating a plasma, said plasma reactor comprising one or more gas inlets configured for introducing a feed gas into the plasma reactor, and a gas outlet for evacuating a gas flow of converted and unconverted feed gas from the plasma reactor, characterized in that the device further comprises
a chamber coupled to the plasma reactor, wherein the chamber is configured for holding a fixed bed of solid reactant material and for receiving said gas flow of converted and unconverted feed gas evacuated through the gas outlet of the plasma reactor, and wherein the chamber further comprises: a supply throughput for filling the chamber with the solid reactant material so as to form the fixed bed of solid reactant material and at least one gas exhaust window for extracting a product gas from the chamber,
a silo for storing a stock of the solid reactant material, and wherein the silo comprises a bottom side having a bottom opening for evacuating solid reactant material from the silo, and
a connecting tube connecting the bottom opening of the silo with the supply throughput of the chamber, and wherein the silo and the connecting tube are configured such that, when the device is in operation and solid reactant material is being depleted in the chamber, a flow of solid reactant material from the silo to the chamber is induced so as to maintain the chamber filled with the solid reactant material, and wherein said flow of solid reactant material from the silo to the chamber is induced by a gravitational force or at least partly by a gravitational force.

2. The device of claim 1, wherein the plasma reactor comprises a central reactor axis Z passing through said at least one gas outlet of the plasma reactor, and wherein said chamber is elongating along said central reactor axis from a first end to a second end, and wherein the first end of the chamber comprises an axial entrance opening, and wherein the gas outlet of the plasma reactor is facing said axial entrance opening of the chamber.

3. (canceled)

4. The device of claim 2, wherein the chamber comprises at least a circumferential wall extending between the first end and the second end, and wherein the supply throughput is made through the circumferential wall, and wherein said at least one gas exhaust is made through the circumferential wall of the chamber, or alternatively wherein said at least one gas exhaust is made through an axial end wall at the end of the chamber.

5. (canceled)

6. The device of claim 2, wherein said silo is extending along a central silo axis S from the bottom side to an upper side of the silo, and wherein said central silo axis S is essentially perpendicular to the central reactor axis Z, and wherein said connecting tube is a straight tube oriented parallel with the central silo axis S.

7. (canceled)

8. The device of claim 2, wherein said silo is extending along a central silo axis S from the bottom side to an upper side of the silo, and wherein said central silo axis S is essentially parallel with the central reactor axis Z of the plasma reactor, and wherein said connecting tube comprises at least one straight tube portion wherein a central axis of the straight tube portion is oriented at an angle between 30° and 60° with respect to said central reactor axis Z.

9. (canceled)

10. The device of claim 1, wherein said silo is extending along a central silo axis S from the bottom side to an upper side of the silo and wherein the silo is oriented such that an angle ϕ between said central silo axis S and an axis of gravity (G) is in a range: 0°≤ϕ≤45°.

11. The device of claim 2, wherein said device is configured such that when in operation said central reactor axis Z is essentially perpendicular with an axis of gravity G, and wherein said silo is extending along a central silo axis S from the bottom side to an upper side of the silo, and wherein an angle β between said central silo axis S and said central reactor axis Z is in a range: 45°≤β≤90°.

12. The device of claim 2, wherein said device is configured such that when in operation said central reactor axis Z is essentially parallel with an axis of gravity G, and wherein said silo is extending along a central silo axis S from the bottom side to an upper side of the silo, and wherein an angle β between said central silo axis S and said central reactor axis Z is in a range: 0°≤3≤45°.

13. (canceled)

14. The device of claim 1, comprising a main gas transportation tube for further transporting said product gas extracted from the chamber.

15. (canceled)

16. (canceled)

17. The device of claim 1, wherein said connecting tube is extending from a first tube end to a second tube end, and wherein the first tube end is coupled to the bottom opening of the silo and the second tube end is coupled to the supply throughput of the chamber.

18. The device of claim 1, wherein the silo comprises a stimulation device configured for stimulating a mass flow of solid reactant material within the silo, wherein the stimulation device is any of or a combination of: a rotation mechanism, a translation mechanism or a vibration mechanism.

19. (canceled)

20. (canceled)

21. The device of claim 1, wherein said plasma reactor comprises at least a first electrode and a second electrode electrically insulated from the first electrode, wherein a wall opening made through said second electrode is forming said gas outlet of the plasma chamber, and wherein said first electrode is a high-voltage cathode and said second electrode is a grounded anode.

22. (canceled)

23. The device of claim 1, further comprising an oxygen sensor arranged in said main gas transportation tube for measuring oxygen concentration and a controller for controlling said flow of solid reactant material from the silo to the chamber and for controlling the removal of depleted reactant material from the chamber, said controller being adapted for controlling said flow of solid reactant material from the silo to the chamber and removal of said depleted reactant material from the chamber based on at least an oxygen concentration in said main gas transportation tube.

24. The device according to claim 23, wherein said controller is adapted for triggering the flow of solid reactant material from the silo to the chamber and removal of depleted reactant material from the chamber when said oxygen concentration passes above a predetermined threshold value or to keep said oxygen concentration within a predetermined range.

25. (canceled)

26. The device according to claim 1, wherein said chamber is configured for allowing the process of mixing the reactant material in said chamber, and wherein the chamber comprises a mixing means or mixing device arranged and adapted for mixing reactant material such as carbon particles in the chamber.

27. (canceled)

28. The device according to claim 26, wherein said mixing device comprises at least one or a plurality of vibrating or rotating pins arranged in said chamber or a screw or helical screw conveyer arranged in the chamber.

29. (canceled)

30. (canceled)

31. (canceled)

32. (canceled)

33. The device according to claim 22, further comprising a means or device for propelling said reactant material towards said port for extraction of depleted reactant material in said chamber, and wherein said means for propelling comprises a screw or helical screw conveyer arranged in the chamber.

34. (canceled)

35. A method for gas conversion comprising:
providing a plasma reactor for generating a plasma, wherein the plasma reactor comprises one or more gas inlets configured for introducing a feed gas into the plasma reactor and a gas outlet for evacuating a gas flow of converted and unconverted feed gas from the plasma reactor,
providing a chamber fillable with a solid reactant material,
coupling the chamber to the plasma reactor such that a gas flow of converted and unconverted feed gas evacuated through the gas outlet of the plasma reactor is receivable in the chamber through an entrance opening of the chamber,
storing a stock of the solid reactant material in a silo,
using a connection tube for connecting a bottom opening of the silo with a supply throughput in the chamber for supplying reactant material,
positioning the silo and the connecting tube with respect to the chamber such that the solid reactant material can flow through the connecting tube from the silo to the chamber by a gravitational force or at least partly by a gravitational force,
filling the chamber with solid reactant material so as to form a fixed bed of solid reactant material within the chamber,
introducing a feed gas in the plasma reactor, operating the plasma reactor for forming a plasma and generating a gas flow of converted and unconverted feed gas that is received by the chamber such that the converted and/or unconverted feed gas can interact with the fixed bed of solid reactant material,
during operation of the plasma reactor, maintaining the silo connected with the chamber through the connecting tube such that if solid reactant material in the chamber is being depleted, a flow of solid reactant material from the silo to the chamber is induced so as to maintain the chamber filled with solid reactant material, and wherein said flow of reactant material from the silo to the chamber is induced by gravitational force or at least partly by gravitational force, evacuating a product gas from the chamber.

36. The method of claim 35, wherein the reactant material is carbon and wherein the method further comprises: before storing the carbon in the silo, pre-treating the carbon to remove hydrogen-containing and/or oxygen-containing functional groups from the carbon.

37. (canceled)

38. The method of claim 35, wherein the solid reactant material is carbon in a form of carbon pellets or carbon grains, and wherein the feed gas comprises at least CO₂, and wherein the product gas evacuated from the chamber comprise at least CO.

39. (canceled)

40. (canceled)
